(19) United States
(12) Patent Application Publication
(10) Pub. No.: US 2024/0095822 A1
(43) Pub. Date: Mar. 21, 2024

(54) INFORMATION PROCESSING APPARATUS, METHOD, AND MEDIUM

(71) Applicant: Rakuten Asia Pte. Ltd., Singapore (SG)

(72) Inventors: Gaurav KUMAR, Singapore (SG); Vishal KSHIRSAGAR, Singapore (SG); Tomohiko YAMASHITA, Tokyo (JP); Daiki MACHIDA, Tokyo (JP); Yin WU, Tokyo (JP); Subrata GHOSH, Tokyo (JP); Mariko KAWASAKI, Tokyo (JP); Ashley JAIN, Tokyo (JP); Takashi UMEDA, Tokyo (JP)

(73) Assignee: Rakuten Asia Pte. Ltd., Singapore (SG)

(21) Appl. No.: 18/468,140

(22) Filed: Sep. 15, 2023

(30) Foreign Application Priority Data
Sep. 16, 2022 (JP) 2022-147702

(51) Int. Cl. G06Q 40/03

(52) U.S. Cl. CPC G06Q 40/03

(57) ABSTRACT

An information processing apparatus includes: a factual attribute determining unit that determines a factual attribute that can be confirmed to be a fact with respect to a user based on user-provided data having been provided by the user oneself or history data of the user; an inferred attribute determining unit which determines an inferred attribute having been inferred with respect to the user based on user-related data including at least the factual attribute related to the user; and a credit score inferring unit that infers a credit score to be set to the user based on an attribute data group including the factual attribute and the inferred attribute related to the user.

### CROSS-REFERENCE TO RELATED APPLICATION(S)

This application claims priority to and the benefit of Japanese Patent Application No. 2022-147702, filed on Sep. 16, 2022, the disclosure of which is expressly incorporated herein by reference in its entirety for any purpose.

### FIELD

The present disclosure relates to a technique for supporting an assessment of a user.

### BACKGROUND

Conventionally, a determination apparatus including a user information acquiring unit that acquires action information indicating an action of a user and a credit determining unit that determines, based on the action information, a credit related to the user's ability to repay a loan in the future has been proposed (refer to Japanese Patent Application Publication No. 2021-174039).

In addition, conventionally, an order settlement apparatus including an identification information acquiring unit that acquires user identification information including a telephone number from a terminal apparatus of a user having accessed an online store, an order data acquiring unit that acquires order data of the user, an authentication information acquiring unit that acquires, from the terminal apparatus, authentication information having been authenticated using the acquired telephone number, and a determining unit that determines a propriety of order settlement by the user using the acquired order data (refer to Japanese Patent Application Publication No. 2020-098491).

### SUMMARY

Conventionally, techniques for calculating a user's score that represents a credit or the like of a user based on history data of the user have been proposed. However, since information that can be directly comprehended as a fact from history data or the like of an object user is mainly handled as attributes of the user when calculating a user's score, there is room for improvement in terms of realizing, for example, calculation of a user's score that utilizes overall attributes of a user including the user's inferred persona (the user's personality and a trend in actions of the user) in a unified manner.

In consideration of the problem described above, an object of the present disclosure is to realize information processing for reflecting overall attributes of a user on a user's score in a unified manner.

An example of the present disclosure is an information processing apparatus including: factual attribute determining means that determines a factual attribute that can be confirmed to be a fact with respect to a user based on user-provided data having been provided by the user oneself or history data of the user; inferred attribute determining means which determines an inferred attribute having been inferred with respect to the user based on user-related data including at least the factual attribute related to the user; and credit score inferring means that infers a credit score to be set to the user based on an attribute data group including the factual attribute and the inferred attribute related to the user.

The present disclosure can be comprehended as an information processing apparatus, an information processing system, an information processing method executed by a computer, or an information processing program which a computer is caused to execute. In addition, the present disclosure can also be comprehended as a recording of such a program on a recording medium that is readable by an apparatus such as a computer, a machine, or the like. In this case, the recording medium that is readable by a computer or the like refers to a recording medium which stores information such as data or a program by an electric action, a magnetic action, an optical action, a mechanical action, or a chemical action and which can be read by a computer or the like.

According to the present disclosure, information processing for reflecting overall attributes of a user on a user's score in a unified manner can be realized.

### BRIEF DESCRIPTION OF THE DRAWINGS

FIG. 1 is a schematic diagram showing a configuration of an information processing apparatus according to an embodiment;

FIG. 2 is a diagram showing an outline of a functional configuration of the information processing apparatus according to the embodiment;

FIG. 3 is a diagram showing an outline of determination processing of an inferred attribute according to the embodiment;

FIG. 4 is a simplified diagram of user's score inference processing according to the embodiment;

FIG. 5 is a simplified diagram of a concept of a decision tree of a machine learning model that is adopted in the embodiment;

FIG. 6 is a flow chart showing a flow of machine learning processing according to the embodiment; and

FIG. 7 is a flow chart showing a flow of user's score inference processing according to the embodiment.

### DESCRIPTION EMBODIMENTS

Hereinafter, an embodiment of an information processing apparatus, a method, and a program according to the present disclosure will be described with reference to the drawings. However, it should be noted that the embodiment described below merely represents an example of implementing the present disclosure and is not intended to limit the information processing apparatus, the method, and the program according to the present disclosure to the specific configurations described below. When implementing the present disclosure, a specific configuration may be adopted as deemed appropriate in accordance with the embodiment and various improvements and modifications may be made. The present invention can respectively adopt at least parts of the components in each of the embodiment and variations to be described later.

In the present embodiment, a description will be given of an embodiment in a case where the technique according to the present disclosure is implemented for the purpose of managing and/or utilizing a user's score indicating some kind of measure (for example, credit) related to the user. However, the technique according to the present disclosure can be widely used as a technique for supporting user assessment such as inferring a user's score or the like and an object of application of the present disclosure is not limited to the example presented in the embodiment.

System Configuration

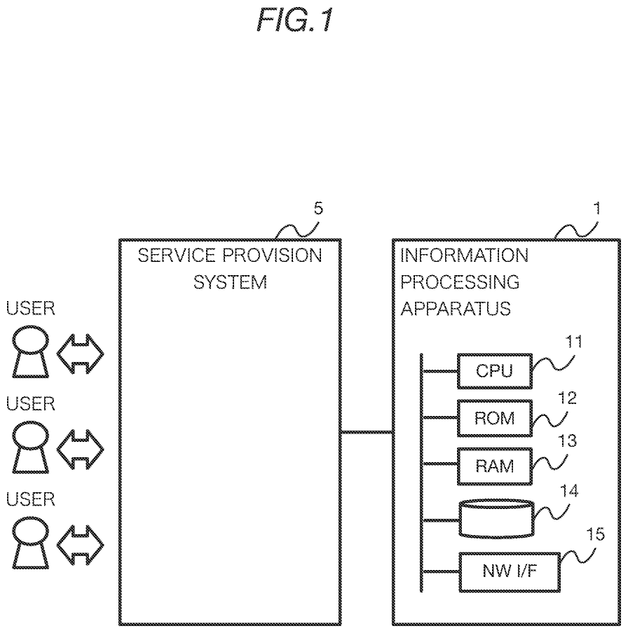

FIG. 1 is a schematic diagram showing a configuration of an information processing system according to the present embodiment. In the information processing system according to the present embodiment, an information processing apparatus 1 and one or a plurality of service provision systems 5 are connected so as to be capable of communicating with each other. A user is user of a service provided by the service provision system 5 and receives provision of the service by accessing the service provision system 5 from a user terminal.

The information processing apparatus 1 is a computer including a CPU (Central Processing Unit) 11, a ROM (Read Only Memory) 12, a RAM (Random Access Memory) 13, a storage apparatus 14 such as an EEPROM (Electrically Erasable and Programmable Read Only Memory) or an HDD (Hard Disk Drive), and a communication unit 15 such as an NIC (Network Interface Card). However, it should be noted that with respect to a specific hardware configuration of the information processing apparatus 1, components may be omitted, replaced, or added as deemed appropriate in accordance with embodiments. In addition, the information processing apparatus 1 is not limited to an apparatus made of a single housing. The information processing apparatus 1 may be realized by a plurality of apparatuses using so-called cloud technology or distributed computing technology.

The information processing apparatus 1 manages a user's score for each user and provides the service provision system 5 with the user's score. The service provision system 5 is capable of customizing service with respect to an object user in accordance with a user's score provided by the information processing apparatus 1.

The service provision system 5 is a computer including a CPU, a ROM, a RAM, a storage apparatus, a communication unit, an input apparatus, and an output apparatus (not illustrated). In addition, the system and the terminal are not limited to apparatuses made of a single housing. The system and the terminal may be realized by a plurality of apparatuses using so-called cloud technology or distributed computing technology.

Examples of the service provided by the service provision system 5 include an online shopping service, an online reservation service, a credit card/deferred payment service, an electronic money settlement service, an operation center service, and a map information service. It is assumed that “deferred payment” is not limited to services referred to as so-called Buy Now Pay Later (BNPL) and includes purchasing of all kinds of products/services using deferred payments.

Services provided by the service provision system 5 are not limited to the examples in the present embodiment. In addition, the service provision system 5 notifies the information processing apparatus 1 of user-related data when providing a service. In this case, the user-related data includes use history data of services by the user. Contents of the use history data of services vary in accordance with contents of services and include, for example, history data of positional information of the user, payment history data of a credit card transacted amount/deferred payment transacted amount, electronic money user history data, transaction history data (including purchase history data of products or the like), reservation history data, and operation history data with respect to the user from an operation center.

Conventionally, techniques for calculating a user's score that represents a credit or the like of a user based on history data of the user have been proposed. However, since information that can be directly comprehended as a fact from history data or the like of an object user is mainly handled as attributes of the user when calculating a user's score, there is room for improvement in terms of realizing calculation of a user's score that utilizes overall attributes of a user including in a unified manner. In particular, there is room for improvement in conventional methods in terms of reflecting insight derived from each piece of information comprehended as a fact on a single index (user's score) in a unified manner given that each piece of such information is fragmentary by nature.

In consideration of the matter described above, the information processing apparatus according to the present disclosure is configured to obtain a user's score which can be used in a wide variety of applications and which is not solely based on data related to credit transactions such as credit card use. Therefore, in the information processing apparatus according to the present disclosure, a machine learning model which uses user attribute data or the like as input and which outputs a user's score is used. The attribute data that is used as input in this case may include data indicating a default (debt default) in deferred payment. Since using various kinds of attribute data as input enables the information processing apparatus according to the present disclosure to calculate a universal and generalized user's score generated by reflecting overall attributes of a user in a unified manner and enables a calculated user's score to be used even in a service (for example, a new service) which has hardly any user data or of which use of user data is limited, for example, a cold-start problem may possibly be addressed. Note that “attribute data” can be replaced with simply “attribute” in the present embodiment.

In this case, user attribute data includes factual attribute data and inferred attribute data. For example, attribute data includes data represented in a data format such as a score (for example, a continuous value of 0 or more and 1 or less) or a label (for example, two values corresponding to presence/absence or right/wrong). However, a format of attribute data is not limited to the examples described in the present disclosure.

Factual attribute data is data indicating a factual attribute that can be confirmed to be a fact with respect to a user based on user-provided data obtained by being provided by the user oneself or history data or the like collected with respect to the user. Examples of user-provided data include registry data such as a name, an email address, a telephone number, an address, a workplace, or a school registered by the user oneself and data obtained as a result of the user oneself filling out a questionnaire or the like. Examples of history data include use history data of an electronic commerce service provided by the service provision system 5 described above. Factual attribute data is preferably data in which the user-provided data and the history data described earlier have been converted into a data format suitable for marketing and/or analytical purposes. For example, factual attribute data that can be obtained based on use history data include a genre/category or a brand of products/services frequently used by the user and a commercial area, a recreational destination, a sightseeing destination, or the like frequently visited by the user.

The user-provided data may handle any category in accordance with a registered name, a registered email address, or the like as a factual attribute. For example, a factual attribute may be any category indicating whether or not a registered email address is classified as free mail, any category indicating a geographical area or a mobile carrier corresponding to a registered telephone number or indicating whether or not a mobile carrier is a prescribed mobile carrier, any category indicating a line of business or a business category corresponding to a registered workplace, or any category indicating a school type, a rate of advancement to the next higher level of education, or a deviation score band corresponding to a registered school.

The present embodiment can exemplify the following statuses during a prescribed period which a service provider can confirm in the electronic commerce service described above as a factual attribute (factual attribute data) that can be obtained based on use history data. Examples of a factual attribute include a transaction status related to a product or a service, an order status related to a product or a service, an order cancellation status related to a product or a service, a contractual status related to a product or a service, a subscription status related to a product or a service, a use status related to a product or a service, a listing status related to a product or a service, a bid status related to a product or a service, a view status of a page or a site related to a product or a service, an acquisition status of an electronic value including points, a use status of an electronic value including points, an acquisition status of a coupon or a voucher, a use status of a coupon or a voucher, a status of account activity of a bank account, and a user status of means of settlement including credit cards.

In addition, inferred attribute data is data indicating an inferred attribute that is obtained by inference based on user-provided data, history data, factual attribute data, or the like. In the present embodiment, inferred attribute data includes characteristics of a user or the like having been inferred or predicted using a machine learning technique. Inferred attribute data is preferably data with respect to an attribute that affects an action (behavior) of the user when used for targeting.

As an inferred attribute, the present embodiment can exemplify the following actions (behavior) that the user may take and a probability thereof during a prescribed period in a transaction service not limited to an electronic commerce service. Examples of an action of the user indicated by an inferred attribute include: possession, management, or protection of a thing that is either a prescribed tangible object or a prescribed intangible object; possession, management, or protection of a thing of a prescribed type; an interest or pursuit towards a prescribed thing or act; possession, management, or protection of a thing with a prescribed function; possession, management, or protection of a thing with a prescribed appearance; possession, management, or protection of a thing with a value equal to or higher than a prescribed amount; a transaction of a product or a service accompanied by a settlement of an amount equal to or higher than a prescribed amount; a consumption action such as dining out or alcohol consumption accompanied by a settlement of an amount equal to or higher than a prescribed amount; a consumption action such as dining out or alcohol consumption accompanied by a movement over a prescribed distance or more; a consumption action such as dining out or alcohol consumption accompanied by a prescribed number of companions or more; a movement such as travel accompanied by a settlement of an amount equal to or higher than a prescribed amount; a settlement accompanied by a movement such as travel over a prescribed distance or more; a movement such as travel accompanied by a prescribed number of companions or more; lodging accompanied by a settlement of an amount equal to or higher than a prescribed amount; lodging accompanied by a movement over a prescribed distance or more; lodging accompanied by a prescribed number of companions or more; a purchase or a contract of a financial instrument of a prescribed amount or more; a financial transaction accompanied by a settlement of an amount equal to or higher than a prescribed amount; deposit and saving or a deposit and withdrawal related to an amount equal to or higher than a prescribed amount; and a debt default related to an amount equal to or higher than a prescribed amount. In addition, as an inferred attribute, the present embodiment may exemplify a part of a demographic attribute, a behavioral attribute, and a psychographic attribute to be described later.

In the present embodiment, a weight is set for each piece of attribute data. A weight indicates a degree of correlation between attribute data and a user's score when the attribute data is used to calculate the user's score and, every time an appropriateness of the user's score is assessed by a machine learning unit 24 to be described later, parameters of a model are adjusted so that the user's score becomes a more appropriate value. For example, a weight corresponding to each piece of attribute data is equivalent to a weight corresponding to each node (each regression tree) of a model for calculating a user's score such as a decision tree model to be described later and is appropriately determined during a process of calculating a user's score. For example, a user's score is determined based on a weight of each node.

In this case, an attribute data group may include a demographic attribute, a behavioral attribute, or a psychographic attribute. Examples of a demographic attribute include sex (gender), a family structure, race, nationality, and age, a behavioral attribute may be based on use history data of a service and examples thereof include use/non-use of borrowing cash on credit, use/non-use of revolving credit, a history of account activity related to a prescribed account, a history of business transactions related to some kind of product/service including gambling or lottery (which may include a history of online transactions at online marketplaces), and a history of movement by the user using positional information and location information, and examples of a psychographic attribute include a tendency related to gambling or lottery. However, attributes of a user that can be used are not limited to the examples described in the present embodiment. For example, a “time required by an operation (a call or the like)” or “an amount of transactions using a credit card/an amount of use of deferred payments” from an operation center service or the like may also be used as an attribute.

A demographic attribute and a behavioral attribute may be handled as factual attributes. A psychographic attribute may be handled as an inferred attribute. Note that an attribute categorized as a demographic attribute may be an inferred attribute having been inferred based on a factual attribute based on user-provided data or history data. In a similar manner, an attribute categorized as a behavioral attribute may be an inferred attribute having been inferred based on a factual attribute based on user-provided data or history data. A psychographic attribute may be a factual attribute based on user-provided data that includes a result of an input of an intention by a user as an example.

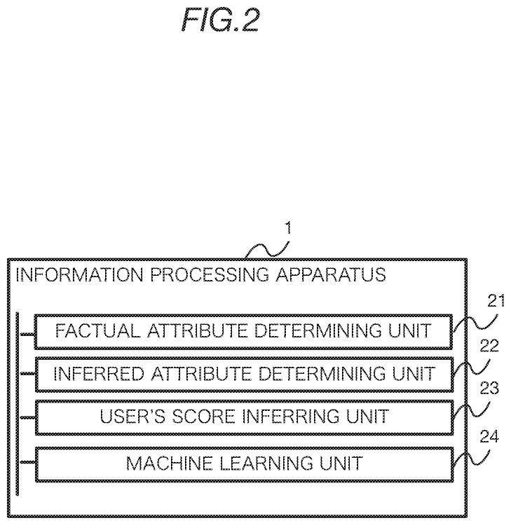

FIG. 2 is a diagram showing an outline of a functional configuration of the information processing apparatus 1 according to the present embodiment. When a program recorded in the storage apparatus 14 is loaded to the RAM 13 and executed by the CPU 11 and each piece of hardware included in the information processing apparatus 1 is controlled according to the program, the information processing apparatus 1 functions as an information processing apparatus including a factual attribute determining unit 21, an inferred attribute determining unit 22, a user's score inferring unit 23, and a machine learning unit 24. While each function included in the information processing apparatus 1 is to be executed by the CPU 11 that is a general-purpose processor in the present embodiment and in other embodiments to be described later, alternatively, a part of or all of the functions may be realized by one or a plurality of dedicated processors.

The factual attribute determining unit 21 determines factual attribute data that can be confirmed to be a fact with respect to a user based on user-provided data having been provided by the user oneself and/or history data of the user. In the present embodiment, the factual attribute determining unit 21 determines factual attribute data related to the user using a method such as aggregating user-provided data and/or history data, determining a relevant attribute by referring to other data such as maps, and using user-provided data and/or history data as it is. While a method of determining factual attribute data related to a user based on user-provided data and/or history data of the user is adopted in the present embodiment, factual attribute data related to the user may be acquired by other methods.

The inferred attribute determining unit 22 determines inferred attribute data having been inferred with respect to an object user based on at least user-related data including one or a plurality of pieces of factual attribute data determined with respect to the user by the factual attribute determining unit 21. In the present embodiment, the inferred attribute determining unit 22 determines an inferred attribute based on an output value obtained by inputting user-related data including one or a plurality of pieces of factual attribute data related to an object user to an attribute inference model that is a machine learning model. In the present embodiment, an output value from the attribute inference model is a value indicating a probability of the object user having a prescribed inferred attribute and the inferred attribute determining unit 22 determines that the object user has the inferred attribute when the output value obtained from the attribute inference model is within a prescribed range. When it is determined that the object user has a prescribed inferred attribute, the inferred attribute determining unit 22 sets a label of attribute data having been inferred with respect to the object user to a value indicating a presence/absence of an attribute or a type of an attribute. In addition, inferred attribute data may be indicated by a score instead of a label. In this case, the inferred attribute determining unit 22 sets a value indicating a degree (probability) by which the inferred attribute may be applied to the score of the attribute data inferred with respect to the object user. The degree may be an output value of the attribute inference model.

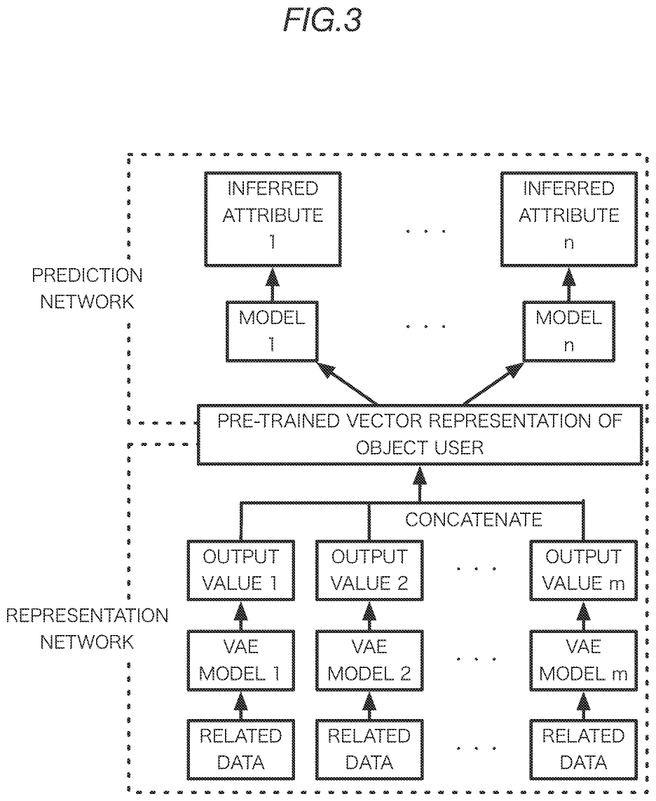

FIG. 3 is a diagram showing an outline of determination processing of an inferred attribute according to the embodiment. While a specific method of inferring another attribute by using data including factual attribute data as an input value to an attribute inference model is not limited, an example of inferring attribute data using a two-layer network constituted of a representation network and a prediction network will be described in the present embodiment.

1. Generation and/or Update of Model of Representation Network

In the present embodiment, the machine learning unit 24 generates and/or updates a VAE (Variational Autoencoder) model in plurality by unsupervised machine learning using training data including at least factual attribute data. Note that by inputting a latent vector output by an encoder in a first half of a VAE to a decoder in a second half of the VAE, the VAE expresses a value (in this case, training data including factual attribute data) input to the encoder in a different format.

2. Generation of Pre-Trained Vector Representation by Representation Network

The inferred attribute determining unit 22 obtains a plurality of output values (vector representations) for each user by inputting object user-related data (including at least factual attribute data of an object user) to the plurality of VAE models and adopts a value obtained by concatenating the output values as a pre-trained vector representation of the object user. In other words, in this case, by acquiring a plurality of types of vector representations in accordance with factual attribute data or the like of a user and concatenating the vector representations, a pre-trained vector representation of the user to be used as an input value to a prediction network model to be described later is obtained. Therefore, the vector representations (output values) to be concatenated may be modified factual attribute data or the like output by the decoder in the second half of the VAE or a latent vector of the user equivalent to the output value of the encoder in the first half of the VAE. In addition, while an example of using a VAE in order to obtain a vector representation is described in the present embodiment, the vector representation may be any vector representation obtained (by encoding) when factual attribute data or the like of the user is input to the model.

3. Generation and/or Update of Model of Prediction Network

The machine learning unit 24 generates and/or updates, for each piece of inferred attribute data to be predicted/inferred, a model of a prediction network by supervised machine learning using teacher data that uses a pre-trained vector representation of each user as an input value and a correct attribute acquired by a user questionnaire or the like as an output value.

4. Inference of Inferred Attribute Data by Prediction Network

The inferred attribute determining unit 22 obtains an inferred value (“inferred attributes (1 to n)” in diagram) of attribute data of an object user by inputting a pre-trained vector representation of the object user to a model of a prediction network generated/updated for inferred attribute data to be predicted/inferred. The inferred value is, for example, a value that predicts a probability of whether or not an object user (a user corresponding to a combination of input factual attribute data or the like) has each inferred attribute (user's persona). For example, when the predicted probability (value) exceeds a prescribed threshold or the like, it can be interpreted that the user has the inferred attribute and inferred attribute data of the object user is determined according to the interpretation result.

The user's score inferring unit 23 infers a user's score to be set to an object user based on an attribute data group including a factual attribute and an inferred attribute related to the object user. In doing so, the user's score inferring unit 23 may subject the determined factual attribute and/or inferred attribute to some kind of processing (normalization, ranking, labeling, or the like) and include the processed factual attribute and/or inferred attribute in the attribute data group or include a score or a label of another type calculated using the determined factual attribute and/or inferred attribute in the attribute data group. In this case, the calculation of a score or a label of another type may involve other machine learning models.

The user's score inferring unit 23 may infer a user's score based on an attribute data group including at least a factual attribute related to an object user or infer a user's score based on an attribute data group including at least an inferred attribute related to the object user. In addition, the user's score inferring unit 23 may infer a user's score based on an attribute data group including at least an attribute corresponding to a node indicating a weight that exceeds a prescribed threshold in a user's score inference model, infer a user's score based on an attribute data group including at least a factual attribute corresponding to a node indicating a weight that exceeds a prescribed threshold in a user's score inference model, or infer a user's score based on an attribute data group including at least an inferred attribute corresponding to a node indicating a weight that exceeds a prescribed threshold in a user's score inference model.

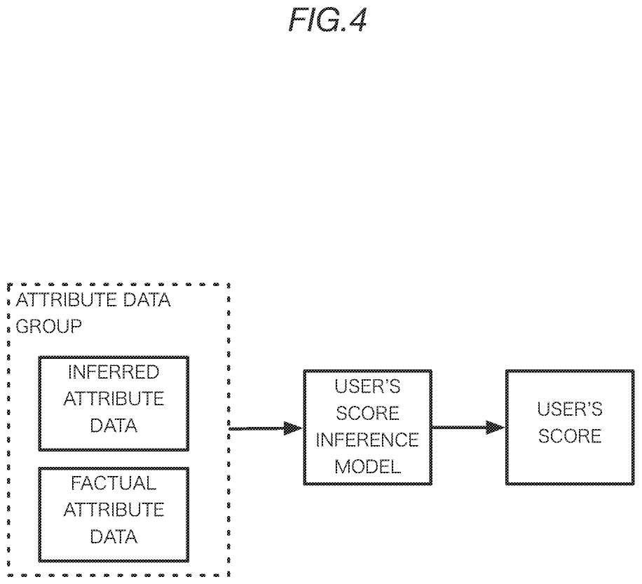

FIG. 4 is a simplified diagram of user's score inference processing according to the embodiment. In the present embodiment, the user's score inferring unit 23 infers (calculates) a user's score to be set to a user by inputting an attribute data group of the user to a user's score inference model. In this case, for example, an output value of the user's score inference model is a user's score normalized/standardized with 0 as a minimum value and 1 as a maximum value.

The machine learning unit 24 generates and/or updates the user's score inference model used in inference of a user's score by the user's score inferring unit 23. A machine learning model for user's score inference is a machine learning model which outputs, when one or a plurality of pieces of attribute data (attribute data group) related to an object user is input, a user's score that indicates some kind of measure (for example, credit) related to the user.

When generating and/or updating a user's score inference model, the machine learning unit 24 creates teacher data defined with the attribute data group of the user as an input value and a user's score related to the user as an output value. In addition, the machine learning unit 24 generates and/or updates the user's score inference model based on the teacher data. As described earlier, the attribute data group to be input to the user's score inference model includes factual attribute data determined by the factual attribute determining unit 21 and inferred attribute data inferred by the inferred attribute determining unit 22 based on user-related data including the factual attribute data, and the attribute data group is combined with a user's score of a corresponding user and input to the machine learning unit 24 as teacher data. The user's score that is set to teacher data may be a user's score determined based on rules or a manually-set (annotated) user's score. Furthermore, the user's score may be a user's score corrected by a manager or the like after previously been output by a user's score inference model.

In addition, in the teacher data, data based on a past payment history (for example, data indicating a default in deferred payment) related to the user may be used as an output value in place of a user's score. In other words, the machine learning unit 24 creates, for each user, teacher data defined with an attribute data group as an input value and data based on a past payment history (for example, presence/absence of a payment, presence/absence of a repayment, or presence/absence of a default) of one or a plurality of users corresponding to the attribute data group (in other words, one or a plurality of users sharing a same combination of attributes) as an output value. In this case, while a format of the data based on a payment history is not limited, for example, the data may be a label based on the payment history. More specifically, a label of 0 (no payment) or 1 (there is record of payment) can be used as the label based on the payment history. Furthermore, as the label based on the payment history, a continuous value within a range of 0 to 1 in accordance with a statistical value of a presence/absence of payment in a user group that shares an attribute data group can be used. When using such teacher data, data output from a machine learning model (for example, when the payment history label is 0 or 1, likelihood data indicating a correctness of the label, and when the payment history label is a continuous value, the label itself) may be adopted as-is as a user's score or the data output from the machine learning model may be subjected to some kind of processing such as normalization or standardization and the processed data may be adopted as a user's score.

A framework of generation/update of a machine learning model that can be adopted as a user's score inference model or the like when implementing the technique according to the present disclosure is based on, for example, an ensemble learning algorithm. As the framework, for example, a machine learning framework (for example, LightGBM) based on a gradient boosting decision tree (GBDT) may be adopted. In other words, as the framework, a machine learning framework based on a decision tree model that causes an error between a correct answer and a predicted value to be inherited between consecutive weak learners (weak classifiers) may be adopted. For example, the predicted value in this case refers to a predicted value of a user's score. Besides LightGBM, the framework may adopt a boosting method such as XGBoost and CatBoost. According to a framework that uses a decision tree, a machine learning model that provides relatively high performance can be generated/updated without as much hassle of parameter adjustment as a framework that uses a neural network. However, a framework of generating/updating a machine learning model that can be adopted when implementing the technique according to the present disclosure is not limited to the example described in the present embodiment. For example, as the learner, another learner such as random forest may be adopted instead of a gradient boosting decision tree or a learner not referred to as a so-called weak learner such as a neural network may be adopted. In addition, particularly, when a learner not referred to as a so-called weak learner such as a neural network is adopted, ensemble learning need not be adopted.

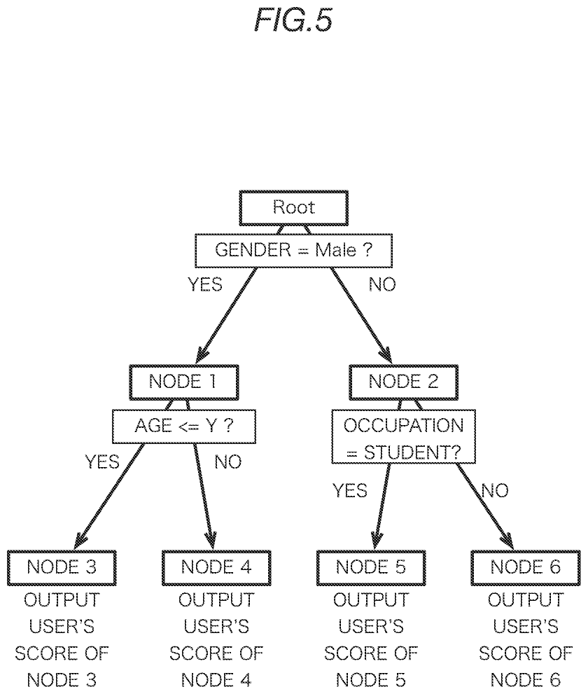

FIG. 5 is a simplified diagram of a concept of a decision tree of a machine learning model that is adopted as a user's score inference model or the like in the present embodiment. When adopting a machine learning framework of gradient boosting based on a decision tree algorithm, optimization of a branch condition of each node of the decision tree is performed. Specifically, in a machine learning framework of gradient boosting based on a decision tree algorithm, a user's score is respectively calculated with respect to a user group having attributes respectively indicated by two children nodes having branched from one parent node and a branch condition of the parent node is optimized so that a difference between the user's scores increases (for example, so that the difference is maximized or the difference equals or exceeds a predetermined threshold) or, in other words, so that the two children nodes branch cleanly. For example, when an attribute indicated by a branch condition of a node is age, an age set as a threshold of a branch may be changed or the branch condition may be changed to an attribute other than age. In this manner, by recursively optimizing branch conditions of all nodes of a decision tree, an inference accuracy of a user's score based on an attribute data group can be improved.

In addition, when the inferred attribute determining unit 22 determines at least a part of an attribute data group using an attribute inference model, the machine learning unit 24 further generates and/or updates an attribute inference model used by the inferred attribute determining unit 22 to determine inferred attribute data based on factual attribute data. As described above, the inference of attribute data in the present embodiment is performed using a two-layer network constituted of a representation network and a prediction network, and details of the generation and/or update of an attribute inference model are as described above in “1. Generation and/or update of model of representation network” and “3. Generation and/or update of model of prediction network”. However, no limit is imposed to a framework of generating/updating a machine learning model that can be adopted in generating and/or updating an attribute inference model. For example, in a similar manner to the user's score inference model described above, a machine learning framework of gradient boosting based on a decision tree algorithm may be adopted.

Flow of Processing

Next, a flow of processing to be executed by the information processing apparatus according to the present embodiment will be described. It is to be understood that specific contents and processing sequences of the processing described below merely represent one example of implementing the present disclosure. Specific processing contents and processing sequences may be selected as deemed appropriate in accordance with embodiments of the present disclosure.

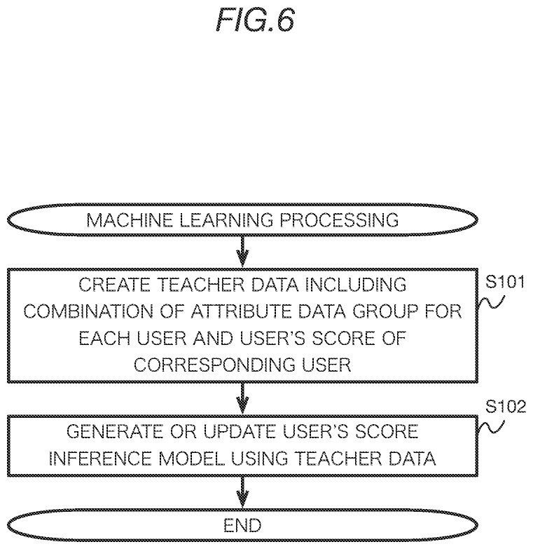

FIG. 6 is a flow chart showing a flow of machine learning processing according to the present embodiment. The processing shown in the present flow chart is executed regularly or at a timing designated by a manager.

In the present embodiment, in the machine learning processing, a user's score inference model is generated and/or updated. The machine learning unit 24 creates teacher data including a combination of an attribute data group for each user accumulated in the past and a user's score determined in advance with respect to a corresponding user (step S101). In addition, the machine learning unit 24 inputs the created teacher data to the user's score inference model and creates and/or updates a user's score inference model to be used in user's score inference by the user's score inferring unit 23 (step S102). Subsequently, the processing shown in the present flow chart is ended.

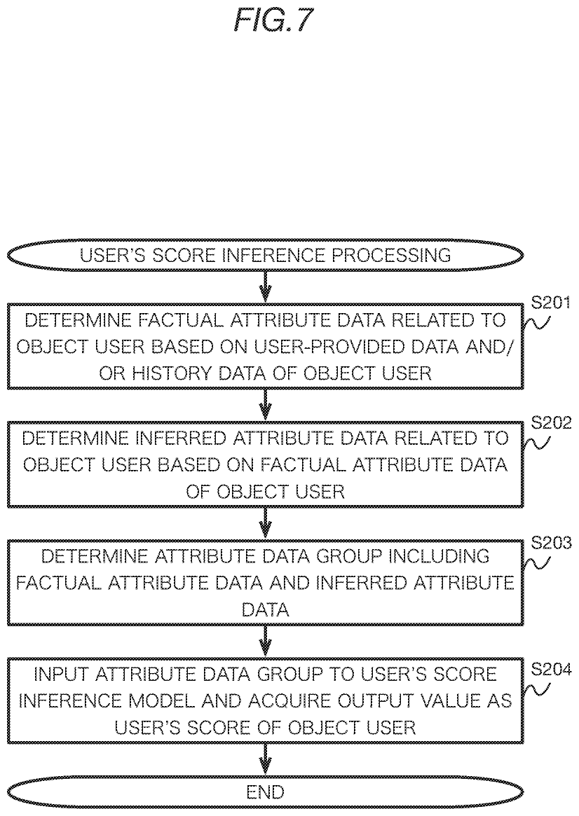

FIG. 7 is a flow chart showing a flow of user's score inference processing according to the present embodiment. The processing shown in the present flow chart is executed regularly or at a designated timing for each user to be an object.

In steps S201 and S202, factual attribute data and inferred attribute data are determined. The factual attribute determining unit 21 determines factual attribute data related to an object user based on user-provided data and/or history data of the object user (step S201). In addition, the inferred attribute determining unit 22 determines inferred attribute data related to the object user based on at least the factual attribute data determined in step S201 (step S202). Subsequently, the processing advances to step S203.

In steps S203 and S204, a user's score is determined and output. The user's score inferring unit 23 determines an attribute data group including the factual attribute data determined in step S201 and the inferred attribute data determined in step S202 (step S203). In addition, the user's score inferring unit 23 inputs the attribute data group determined in step S203 to a user's score inference model and acquires an output value as a user's score set to the user (step S204). However, an inference method of a user's score is not limited to the example described in the present embodiment. For example, a user's score may include a value calculated by inputting an attribute data group into a prescribed function, a prescribed statistical model, or the like that is not a machine learning model. Subsequently, the processing shown in the present flow chart is ended.

The user's score set for each user is provided to other systems such as the service provision system 5 to be utilized in a service provided to an object user by the other systems such as the service provision system 5. For example, the service provision system 5 can identify a low-risk user based on a user's score and provide information about personal loans and insurance services even with respect to users without data created by a credit bureau with respect to the user. In addition, the service provision system 5 can decide whether or not to extend credit based on a user's score even with respect to users without data created by a credit bureau with respect to the users among applicants for a credit card.

Operational Effect

According to the present embodiment, information processing for reflecting overall attributes of a user on a user's score in a unified manner can be realized and a user's score which can be used in a wide variety of applications and which is not solely based on data related to credit transactions can be obtained.

1. An information processing apparatus, comprising:
a memory; and
a processor coupled to the memory, the processor being configured to execute:
determining a factual attribute that can be confirmed to be a fact with respect to a user based on user-provided data having been provided by the user oneself or history data of the user;
determining an inferred attribute having been inferred with respect to the user based on user-related data including at least the factual attribute related to the user; and
inferring credit score to be set to the user based on an attribute data group including the factual attribute and the inferred attribute related to the user, wherein
the processor infers a credit score to be set to the user based on an output value obtained by inputting the attribute data group to a credit score inference model, and
the processor infers a credit score to be set to the user using the credit score inference model generated and/or updated using teacher data that uses the attribute data group as an input value and the credit score determined based on a payment history of deferred payment related to users who share the attribute data group as an output value.

2. The information processing apparatus according to claim 1, wherein
the processor determines the inferred attribute based on an output value obtained by inputting the user-related data including the factual attribute to an attribute inference model.

3. The information processing apparatus according to claim 2, wherein
the processor determines that, when an output value obtained from the attribute inference model which uses the user-related data including the factual attribute as an input value and a value indicating a probability of a user related to the factual attribute having a prescribed inferred attribute as an output value is within a prescribed range, the user has the inferred attribute.

4. The information processing apparatus according to claim 3, wherein
the attribute inference model has a representation network in which, when the user-related data including the factual attribute is input, a vector representation of an object user is obtained as an output value and a prediction network in which, when a vector representation of the object user obtained from the representation network is input, a value indicating a probability of the object user having a prescribed inferred attribute is obtained as an output value.

5. The information processing apparatus according to claim 3, wherein
the attribute inference model of has a representation network in which, when the user-related data including the factual attribute is input, a plurality of vector representations with respect to an object user are obtained as an output value and a prediction network in which, when the plurality of vector representations of the object user obtained from the representation network are concatenated and input, a value indicating a probability of the object user having a prescribed inferred attribute is obtained as an output value.

6. The information processing apparatus according to claim 1, wherein
the processor infers the credit score using the credit score inference model generated and/or updated using a machine learning framework based on a gradient boosting decision tree.

7. A method performed by a computer, the method comprising:
determining a factual attribute that can be confirmed to be a fact with respect to a user based on user-provided data having been provided by the user oneself or history data of the user;
determining an inferred attribute having been inferred with respect to the user based on user-related data including at least the factual attribute related to the user; and
inferring a credit score to be set to the user based on an attribute data group including the factual attribute and the inferred attribute related to the user, wherein
the credit score to be set to the user is inferred based on an output value obtained by inputting the attribute data group to a credit score inference model, and
the credit score to be set to the user is inferred using the credit score inference model generated and/or updated using teacher data that uses the attribute data group as an input value and the credit score determined based on a payment history of deferred payment related to users who share the attribute data group as an output value.

8. A non-transitory computer-readable recording medium having recorded thereon a program causing a computer to execute:
determining a factual attribute that can be confirmed to be a fact with respect to a user based on user-provided data having been provided by the user oneself or history data of the user;
determining an inferred attribute having been inferred with respect to the user based on user-related data including at least the factual attribute related to the user; and
inferring a credit score to be set to the user based on an attribute data group including the factual attribute and the inferred attribute related to the user, wherein
the credit score to be set to the user is inferred based on an output value obtained by inputting the attribute data group to a credit score inference model, and
the credit score to be set to the user is inferred using the credit score inference model generated and/or updated using teacher data that uses the attribute data group as an input value and the credit score determined based on a payment history of deferred payment related to users who share the attribute data group as an output value.
